(19) United States
(12) Patent Application Publication
(10) Pub. No.: US 2010/0176360 A1
(43) Pub. Date: Jul. 15, 2010

(54) BARRIER

(76) Inventor: Daniel Mawby, Victoria (AU)

Correspondence Address: BROOKS KUSHMAN P.C., 1000 TOWN CENTER, TWENTY-SECOND FLOOR, SOUTHFIELD, MI, 48075, US

(21) Appl. No.: 12/440,957

(22) PCT Filed: Sep. 12, 2007
(86) PCT No.: PCT/AU2007/001343

§ 371 Date: Mar. 29, 2010

(30) Foreign Application Priority Data
Sep. 12, 2006 (AU) 2006905015
Oct. 9, 2006 (AU) 2006905583
Dec. 28, 2006 (AU) 2006907313
Feb. 22, 2007 (AU) 2007900922
Jun. 4, 2007 (AU) 2007903013

(51) Int. Cl. A63K 3/00; E04H 17/14; B23P 17/04

(52) U.S. Cl. 256/64; 29/428

(57) ABSTRACT

A barrier fence for horse racing courses and the like having a rail assembly, uprights and ground anchors for the uprights' lower ends. Fence can resiliently deflect under side loads applied to the rail assembly, but in the event of an excessive value of such load, or of an impact load applied directly to an upright, that upright can break away from its ground anchor at its lower end. Multiple breakaway mechanisms can be provided. Upper ends of the uprights are secured to the rail assembly and in the event of an upright breaking away at its lower end it can rotate about a horizontal axis.

### TECHNICAL FIELD

This invention concerns a barrier fence for use in bounding horse racing tracks and other similar applications. The barrier is readily assembled and able to absorb impacts in a safe and predictable manner.

### BACKGROUND ART

In the sport of horse racing, elongate fences are provided to act as boundaries of the actual courses on which the horses race. It is desirable that such fences be able to be installed and relocated reasonably easily, and most importantly that they present the smallest possible hazard to horses and jockeys in the event of one or more of them falling. Barrier fences have been developed for horse—and other racing applications but have not always performed well in these respects.

The present invention provides a barrier fence that is comparatively easy to install, to remove, to relocate and to repair, and that can be designed to restrict the potential for harm to horses and jockeys in the event of a fall or other accident.

### DISCLOSURE OF INVENTION

Barrier fences according to the invention, as described herein, are intended to be suitable for example for use on a horse racing track and for convenience will be described below in that context. However, it is to be understood that they and the methods and principles involved in their construction are potentially applicable to other applications also, for example to barrier fences for other forms of animal racing courses and even for barriers that guide or restrain people in public places.

FIG. 1 shows how barrier fences according to the invention are intended to behave. FIG. 1 shows two aerial perspective views of a portion of a barrier fence 1, with much detail omitted. Barrier fence 1 comprises a continuous rail assembly 2 supported by uprights 3a, 3b, 3c, 3d, 3e whose lower ends are secured to the ground by ground anchors 5. At (a), barrier fence 1 is shown under no external load. At (b), barrier fence 1 is shown under a load (represented by arrow 555) applied laterally to rail assembly 2, and can be seen to have deflected partly by bending of rail assembly 2 and partly by bending of the uprights 3b, 3c, 3d. Load 555 could be for example due to barrier fence 1 being nudged by one or more horses (not shown) racing on the left side of the rail assembly 2 as shown in FIG. 1. Up to a certain level of force 555 it is required that its removal simply cause the barrier fence 1 to return resiliently back to the condition shown at (a).

In FIG. 1(a) the ground anchors 5 are shown to be offset rearwardly from the rail assembly 2. This is to avoid interference with horses' legs and hooves in the event that they race close to rail assembly 2 or nudge and deflect rail assembly 2. It is a further requirement of barrier fence 1 that at the maximum intended value of forces such as force 555, the ground anchors 5 remain offset rearwardly of rail assembly 2.

However, beyond the maximum level of force 555, for example in the case of one or more horses falling or pushing excessively hard on rail assembly 2, it is required that one or more of uprights 3 would separate at or near their lower ends from their ground anchors 5. Separation at or near lower ends of uprights 3 is desirable to avoid injuries to horses and jockeys from, for example, broken uprights 3 extending up from ground level. It is further required that if such separation of uprights 3 occurs, the uprights 3 behave predictably and do not become a further hazard to horses and riders.

It is further desired that barrier fence 1 respond in a predictable and safe manner to impacts directly on uprights 3, for example by unseated riders. Specifically, uprights 3 should again break way at or near their lower ends, and thereafter behave in a safe and predictable manner. To minimize injuries, such breaking away needs to occur at impact loads generally lower than the maximum lateral load 555 on rail assembly.

Finally, if a rider falls on an upright 3 from above, it is desirable that his or her impact lead to as little personal harm as possible.

Accordingly, barrier fences according to the present invention are intended to address these problems.

The invention provides a barrier fence comprising an elongate rail and uprights secured thereto at positions along the rail, wherein an upright is secured at an upper end to the rail and at a lower end to a ground anchor offset transversely in a rearward direction from a position below the rail and wherein the lower end of the upright is adapted to separate from its associated ground anchor in response to an impact load on the upright that has a component directed horizontally and in a direction parallel to the rail.

It is preferred that the lower end of the upright and the ground anchor are configured to in use resist separation of the lower end of the upright from the ground anchor in response to horizontal loads applied transversely to the rail in the rearward direction.

Preferred forms of the means by which the upright can break away under impact loads will now be disclosed.

In a preferred embodiment of a “breakaway” mechanism for the lower end of the upright,
(a) the lower end of the upright comprises a foot member protruding laterally outward and of which a portion is urged upwardly in response to horizontal loads applied transversely to the rail in the rearward direction; and
(b) the ground anchor comprises a formation that at least partially overlies the upwardly urged portion of the foot member so as to resist upward movement thereof.

A frangible component connecting the lower end of the upright to the ground anchor may be arranged to be broken under a specified minimum value of said impact load on the upright so that the lower end of the upright separates from the ground anchor.

Alternatively, the foot member may be snap fittingly held between first and second upright formations comprised in the ground anchor and is releasable in response to the said impact load on the upright.

When the foot member is snap fittingly received between the upright formations the first said upright formation may be received in an inwardly tapering recess formed in an edge of the foot member and presses against the foot member on opposing sides of the recess.

In one embodiment, the first and second upright formations lie at least approximately in a plane transverse to the length of the rail so that the foot member is releasable in either of two opposite directions each corresponding to one of two possible directions of the said impact load component.

The formation that overlies part of the foot member may be secured to one of said upright formations, preferably the first upright formation.

The foot member in use may be supported by an upwardly facing surface of the ground anchor.

Advantageously, the foot member may be rotatable about an axis that extends lengthwise in the lower end of the upright.

The upright may comprise a length of tubing and a lower end fitting secured to a lower end of the tubing with the foot member being comprised in the lower end fitting.

Preferred forms for the additional “breakaway” capability, where included, will now be disclosed. At a position above and adjacent to lower end of the upright, the upright may be adapted to separate into two portions in response to loads applied to the rail or the upright that due to direction or magnitude do not cause separation of the lower end of the upright from the ground anchor.

In one embodiment of this additional breakaway capability:
(a) the upright comprises a length of tubing and a lower end fitting secured to a lower end of the tubing;
(b) the lower end fitting comprises an upstanding stub that is received in a lower end of the tubing; and
(c) the stub has a frangible portion that by failing enables said separation into two portions of the upright.

It is desirable, once the lower end of the upright breaks away under impact loads, that the upright move in a manner that is predictable and likely to minimize harm to animals or persons.

Thus, in a particularly preferred embodiment of a fence according to the invention, the upper end of the upright is secured pivotally to the rail so that on separation of the lower end of the upright from the ground anchor the upright is free to pivot through an angular range without separating from the rail. Said pivoting of the upright on separation of its lower end is preferably about an axis that lies approximately in a plane transverse to the rail and that more preferably is approximately horizontal.

The barrier fence may comprise detent means at the pivot connection between the upright and the rail whereby pivoting of the upright away from the position relative to the rail that it would occupy when secured to the ground anchor requires application to the upright of a greater torque than subsequent pivoting within the angular range.

In one form of the detent means, one of the upright and the rail comprises a male formation and the other of the upright and the rail comprises a female formation and wherein the male formation is receivable in the female formation so as to provide the detent means.

The upright may have a flange that abuts an external surface of the rail, the flange having one of the male and the female formations formed thereon.

In one embodiment with a pivoting upright, the upright comprises an upper end formation that is received and can rotate within an internal space in the rail and that is connected to that part of the upright outside said space by a neck passing through an opening in the rail, the space and the rail being so shaped that the upper end formation is captive in the internal space when the upright is secured to the ground anchor and when the upright is pivoted to any point in the angular range.

The upper end formation may have a surface that is a portion of a male spherical surface with the internal space extending lengthwise in the rail and when seen in cross-section transverse to the rail having a mating female circular surface so as to permit rotation of the upper end formation about the axis. A further surface of the upper end formation may be substantially flat and abut a substantially flat internal surface of the internal space.

In another embodiment, a surface of the upper end formation is a cylindrical surface that slidingly mates with an internal surface of the internal space so as to permit rotation of the upper end formation about the axis.

In still another embodiment the upper end formation comprises a cam that is shaped to hold the upright in a specified position and to permit rotation of the upright away from the specified position on application of a specified minimum torque.

The upper end formation may be so shaped as to be able to be passed through the said opening in the rail and received in the internal space when the upright is in a specified angular position about the said axis and thereafter rotated about the said axis into the said angular range.

Advantageously, the opening into the internal space in the rail is a slot extending lengthwise of the rail and the upper end formation is shaped to be able to pass between upper and lower boundaries of that slot in a particular angular position of the upright. Preferably, in the said particular angular position the upright is rotated approximately 90 degrees about the said axis from its position when secured to the ground anchor.

The upright may comprise a length of tubing and an upper end fitting secured to an upper end of the tubing, the upper end fitting comprising the neck, the upper end formation and a stub that is received and secured in the upper end of the tubing. The upper end fitting may include a flange that abuts an external rearwardly facing surface of the rail both above and below the neck. Preferably, the upper end fitting has a stub extending from a rear face of the flange a portion of the stub being received in the upper end of the tubing and wherein when the fence is erected on a horizontal surface a longitudinal axis of the stub extends rearwardly and downwardly from the flange rear face at an angle below the horizontal of at least 40 degrees and preferably between about 40 and about 60 degrees.

Preferred forms of the upright will now be disclosed.

The upright may comprise:
(a) a length of tubing;
(b) an upper end fitting secured to an upper end of the tubing and having an upper stub received in the upper end of the tubing; and
(c) a lower end fitting secured to a lower end of the tubing and having a lower stub extending upwardly that is received in the lower end of the tubing.

It is preferred that when the fence is erected on a horizontal surface the tubing extends rearwardly and downwardly from the upper end of the tubing at an angle from the horizontal of at least 40 degrees, more preferably between 50 and 60 degrees.

The tubing between the upper and lower stubs may be formed into a smooth arcuate shape in a plane perpendicular to the length of the rail. The smooth arcuate shape of the tubing between the upper and lower stubs may advantageously have an approximately constant radius of curvature.

It is preferred that everywhere between the upper and lower stubs the tubing extends in a direction with a downward component and has no sharp corner.

Preferred forms of the ground anchor will now be disclosed.

Preferably, the ground anchor comprises an upper part that in use lies wholly at or adjacent to ground level and that secured to the lower end of the upright and a lower part that lies below ground level.

Where it is desired to have a re-locatable fence, the lower part may be adapted to be driven into the ground. The lower part may comprise a length of angle with a sharpened bottom edge and that is oriented so that arms of the angle face the rail when seen in horizontal cross-section. The ground anchor may include a plate that in use lies flush with the ground surface and extends rearwardly away from the lower part so as to enhance resistance to movement of the ground anchor under rearwardly directed loads applied to the rail. The said plate may comprise an extension of a plate that abuts the lower end of the upright.

Preferred forms of the rail will now be disclosed.

Preferably, the rail comprises a plurality of constant-cross-section rail lengths joined end to end. The rail lengths may be plastics or metallic extrusions.

The rail may include a coupling means between an adjoining pair of said rail lengths the coupling means comprising:
(a) a bolt member adapted to be received and slideable longitudinally in an internal volume that lies within an external boundary of the rail when seen in cross-section; and
(b) a screw threaded member and a cooperating nut one of the screw threaded member and the nut being captive in the bolt member and the other being tightenable thereto so as to grip a portion of a rail length and secure the elongate member against sliding in the said internal volume.

One of the screw threaded member and the nut is preferably accessible from outside the rail length through a slot in the rail length that communicates with the internal volume.

In a further aspect the invention provides a method for erecting a barrier fence comprising the steps of providing ground anchors let into a ground surface, securing a lower end of an upright to each ground anchor, and securing a rail assembly to upper ends of the uprights.

Preferably, securing of an upright to the rail assembly is in such a manner that in the event of separation of a lower end of an upright separating from its ground anchor the upper end of the upright remains secured to the rail assembly and can rotate about an axis.

Additional features and aspects of the invention are disclosed in the following detailed description.

Note that throughout this specification, the word “comprise” and words derived therefrom such as “comprising” and “comprised”, when used in relation to a set of integers elements or steps are to be taken as indicating that the elements integers or steps are present but not to be taken as precluding the possible presence of other elements integers or steps.

### BRIEF DESCRIPTION OF DRAWINGS

FIG. 1 shows at (a) a perspective view of a barrier fence according to the invention with much detail omitted, and under no load, and at (b) the same view of that barrier now under a load applied laterally to a rail assembly;

FIG. 2 is a perspective view of a portion of a barrier according to the invention.

FIG. 3 is a cross-sectional view of the barrier shown in FIG. 2 the section being taken at station “AA”;

FIG. 4 is a cross sectional view of the barrier shown in FIG. 3, the cross section being taken at station “BB” and certain parts not being shown in sedan;

FIG. 5 is a perspective exploded view showing a lower portion of an upright of the barrier of FIG. 2 and a ground anchor of that barrier;

FIG. 6 is an elevation of the ground anchor shown in FIG. 5;

FIG. 7 is a cross-sectional view of the ground anchor of FIG. 6 the section being taken at Station “CC”, and assembled thereto and shown in cross-section a lower portion of an upright of the barrier;

FIG. 8 is an elevation of a ground anchor for an alternative embodiment of a barrier according to the invention, and a lower portion of an upright thereof;

FIG. 9 is an elevation of a connecting piece for use with the ground anchor shown in FIG. 8, the connecting piece being shown partly sectioned;

FIG. 10 is an elevation of an alternative connecting piece for use with the ground anchor shown in FIG. 8, the alternative connecting piece being shown partly sectioned;

FIG. 11 is an elevation of a second alternative connecting piece for use with the ground anchor shown in FIG. 8;

FIG. 12 is a cross-sectional view of the second alternative connecting piece shown in FIG. 11, the section being taken at Station “DD”;

FIG. 13 is a perspective view of an assembly including rail connector for use in a further barrier according to the invention, with end portions of two rail lengths being shown in chain-dotted lines;

FIG. 14 is a cross-sectional view of the assembly of FIG. 13;

FIG. 15 is a cross-sectional view of a further rail assembly for a further barrier according to the invention, the section being taken at a connection point;

FIG. 16 is an elevation of an alternative embodiment for the upper portion of an upright for another barrier according to the invention, with a section of rail shown in cross-section;

FIG. 17 is a cross-sectional view of the arrangement shown in FIG. 16, the section being taken at station “EE”;

FIG. 18 is a cross-sectional view the same as FIG. 17, save for substitution of a modified version of one part;

FIG. 19 is a cross-sectional view the same as FIG. 17, save for substitution of a second modified version of one part;

FIG. 20 is a perspective view of a connection in a rail assembly of the barrier shown in FIG. 2;

FIG. 21 is a transverse cross-sectional view of the rail assembly shown in FIG. 20, the section being taken at station “FF”;

FIG. 22 is a transverse cross-sectional view of a rail assembly that is an alternative to that of FIG. 21, the section being equivalent in viewpoint to that of FIG. 21;

FIG. 23 is a transverse cross-section of a further rail assembly according to the invention, the section being taken at a point of attachment of an upright and the upright itself not being sectioned);

FIG. 24 is a cross-sectional view of an upper portion of the upright shown in FIG. 23, the cross-section being taken at Station “GG”;

FIG. 25 is a side elevation of an alternative ground anchoring arrangement according to the invention;

FIG. 26 is a cross-sectional view taken at station “26-26” in FIG. 25;

FIG. 27 is a cross-sectional view taken at station “27-27” in FIG. 25;

FIG. 28 is a plan view of a fence portion using the arrangement shown in FIG. 25;

FIG. 29 is an end view of the fence portion shown in FIG. 28, looking in the direction of arrow “Z”;

FIG. 30 is a side elevation of a further alternative ground anchoring arrangement according to the invention;

FIG. 31 is a plan view of an alternative upright upper end fitting according to the invention;

FIG. 32 is a side elevation of the fitting shown in FIG. 31;

FIG. 33 is a side elevation of an upright upper end fitting as shown in FIG. 29;

FIG. 34 is a perspective view of a portion of the barrier fence shown in FIG. 29;

FIG. 35 is a perspective view of an alternative to a specified part shown in FIG. 34;

FIG. 36 is a sectional view taken transverse to a rail assembly of an upright upper end configuration in a further embodiment of the invention.

### MODES FOR CARRYING OUT THE INVENTION

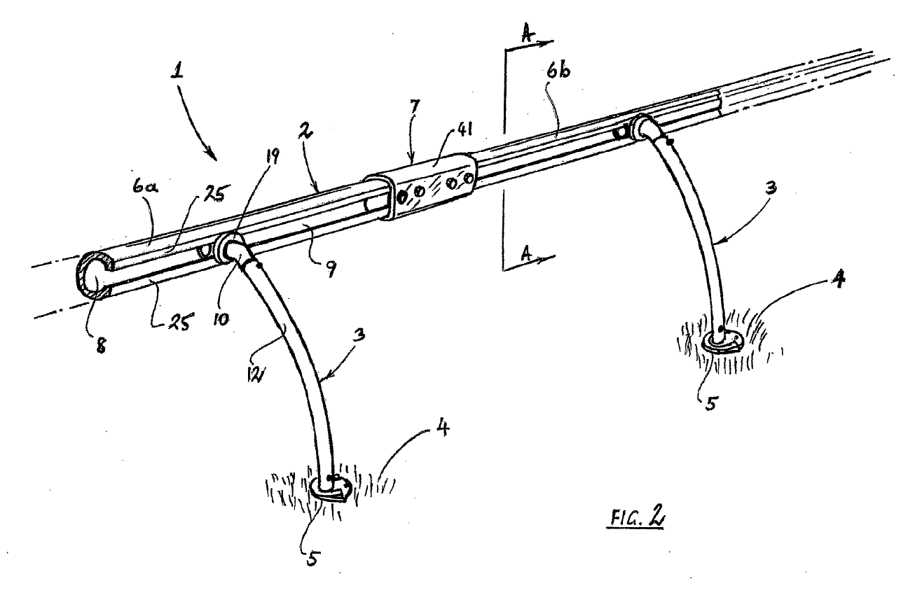

FIG. 2 shows a portion of a first barrier fence 1 according to the invention. Barrier fence 1 comprises a rail assembly 2 supported at spaced apart locations along its length by uprights 3 that are anchored to the ground 4 by anchors 5. Although only two uprights 3 are shown in FIG. 2, and a short length of the rail assembly 2, it is to be understood that barrier fence 1 can be made in any required length by providing a longer rail assembly 2 and more uprights 3 and ground anchors 5 than are shown.

In FIG. 2, barrier fence 1 is shown as seen by an observer positioned on the side of barrier fence 1 opposite that on which horses would pass, the uprights 3 being placed so as not to interfere with the horses' progress. For convenience, the side of the barrier fence 1 on which horses pass will be referred to herein as the “front” side of the barrier fence 1 and the opposite side will be described as the “rear” side of the barrier fence 1. The same convention will be used in respect of rail assembly 2 and its constituent parts.

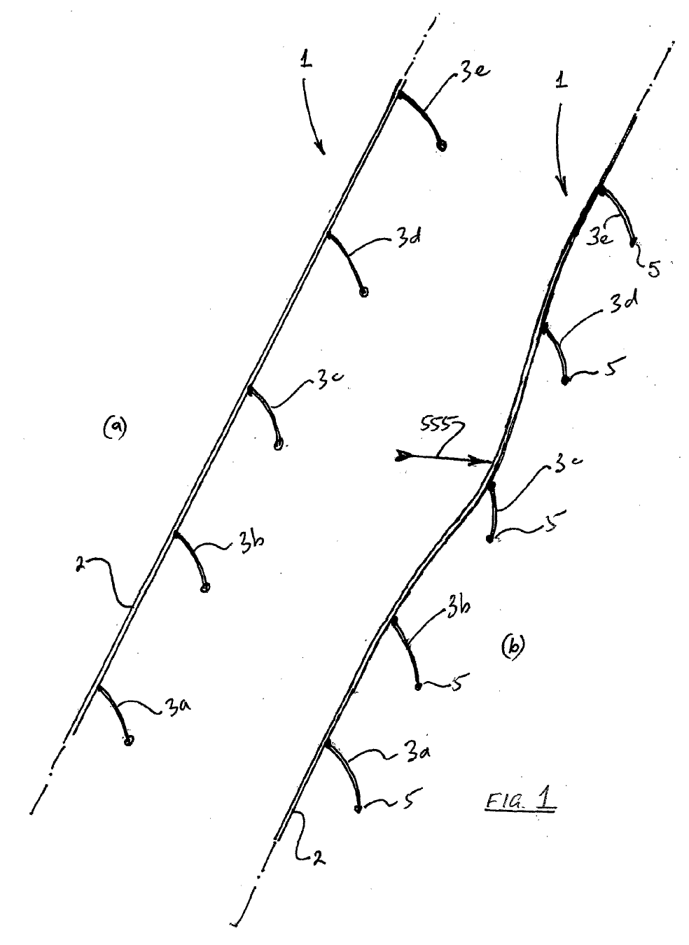

Based on this convention, forces such as force 555 in FIG. 1 are herein described as rearwardly directed, and the deflection of barrier fence 1 as shown in FIG. 1(b) is described as rearward deflection.

Rail assembly 1 comprises firstly a number of rail sections 6 (of which parts of two only, 6a and 6b, are shown in FIG. 2) arranged end-to-end and secondly connection assemblies 7 that connect adjoining ends of the rail sections 6. Thus rail assembly 2 is a continuous elongate structure.

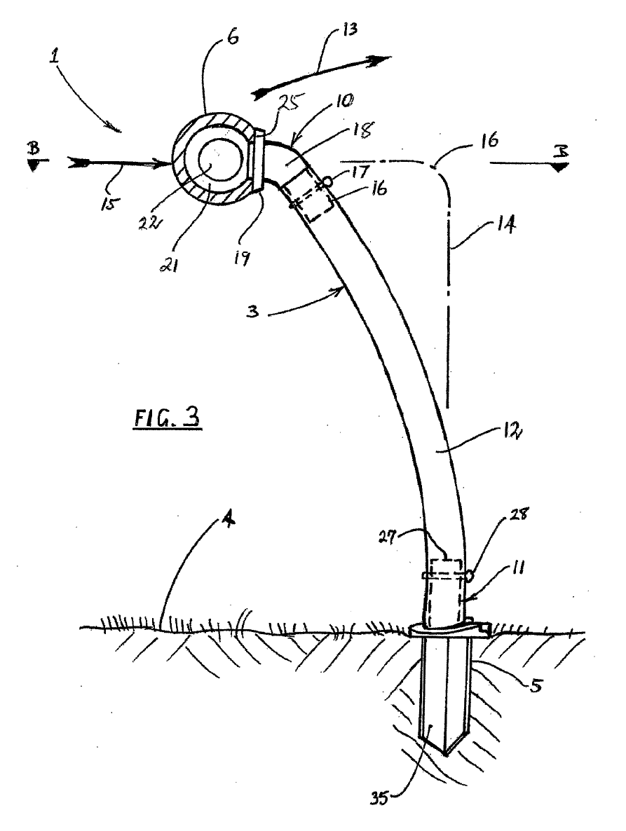

Each rail section 6 is preferably of constant cross-sectional shape along its length, and has, extending lengthwise, an internal space 8 that opens to the rear side of the rail section through a lengthwise slot 9. See also FIGS. 3, 4. Although a C-section shape is shown for rail sections 6, and has the advantages of low wind resistance and of being potentially less harmful to a horse impacting it than many other possible sections, any suitable external shape may be used.

Rail sections 6 may be formed by extrusion in a suitable plastics material or by rolling or extrusion in a suitable metallic material, but this is not to preclude the possible use of any other suitable materials or fabrication methods consistent with the objectives set out above.

It is intended that the rail assembly 2 be sufficiently rigid to hold its shape as a part of barrier fence 1, but to the degree found suitable for the application, to have enough flexibility in bending to deflect to a suitable degree when struck, without shattering, and with enough resilience to spring back after a deflecting force is removed. Choosing the material and rail dimensions to achieve these objectives does not of itself require inventive skill.

Each upright 3 comprises a tube 12 with an upper end fitting 10 for attachment of the upright 3 to a rail section 6 and a lower end fitting 11 for attachment of the upright 3 to ground anchor 5. Tube 12 is sufficiently rigid to ensure that uprights 3 support rail assembly 2 adequately, but sufficiently flexible to deflect rearwardly (as shown by arrow 13 in FIG. 3) when impact loads (as represented by arrow 15) are applied to rail assembly 2, without shattering and with enough resilience to spring back to its original shape after the load is removed. Choosing the material and tube dimensions to achieve these objectives does not of itself require inventive skill. Suitable plastics tube may be used, for example.

Tube 12 has an arcuate shape as seen in the view of FIG. 3. This ensures that the lower end fittings 11 and ground anchors 5 are well rearward of rail assembly 2 so as not to interfere with horses passing on the front side of rail assembly 2 while the upper ends of uprights 3 are close to the rear of rail assembly 2 to minimize hazards to jockeys who may fall over the rail assembly 2. The arcuate shape and this offsetting of the ground anchors 5 also mean that an inwardly directed transverse load (due for example to an impact from a horse) on the front of rail assembly 2 near upright 3 deflects the upper end of tube 12 both rearwardly and (to a lesser degree) upwardly as shown by arrow 13. This upward movement of the top of tube 12 and nearby parts of rail assembly 2 is believed to progressively increase the tendency for a horse nudging rail assembly 2 to withdraw from the rail assembly 2.

The arcuate shape shown is preferred, but may be varied if required. For example the radius of curvature may be increased somewhat beyond that shown. It may even be made substantially straight. Dotted line 14 in FIG. 3, however, shows a possible alternative shape (i.e. tube centreline shape) for tube 12 that is less preferred. If tube 12 had the shape shown by broken line 14, a lateral load (as shown by arrow 15) on the rail assembly 2 would lead to more concentrated stresses at the lower end of tube 12 and in the corner area 16 with a greater risk of the tube failing there in such a manner as to present an impaling risk to a horse or falling jockey. Further, even if there is no failure of a tube when in the shape shown at 14, a rider falling onto such a tube from above would likely be harmed more than if it had the shape shown in solid lines in FIG. 3, which tends to shed loads dropping on it. Finally, the initial movement of rail assembly 2 under an impact load in the direction of arrow 15 would likely have a smaller upward component than if tube 12 had the shape shown in solid lines in FIG. 3. Generally it is preferred that tube 12 extend smoothly between its lower and upper end fittings.

The method by which uprights 3 of barrier fence 1 are secured to the rail assembly 2 will now be described, by reference to FIGS. 2, 3 and 4. FIG. 4 shows a view from above of a rail section 6 and two uprights 3a, 3b of which one 3a is in a working position secured to a ground anchor 5 and the other 3b is in a position where it is being initially secured to rail section 6 before securing to a ground anchor (not shown). Upper end fitting 10 comprises a stub 16 that is close-fittingly received in the upper end of tube 12, with a securing pin 17 extending through tube 12 and stub 16. From stub 16 a transition piece 18 extends to a flange 19. On the opposite side of flange 19 is a neck 20 and secured to neck section 20 is a ball member 21 whose shape is spherical save for two parallel flat surfaces 22 and except where ball member 21 is truncated and secured to neck 20. Flat surfaces 22 are so spaced apart that ball member 21 can be inserted through slot 9 when surfaces 22 are aligned with slot 9 in the way shown by upright 3b in FIG. 4. Then, by rotation of upright 3 as shown by arrow 23 about a horizontal axis 24 with ball member 21 within space 8, upright 3b can be brought to a position where it can be secured to ground anchor 5 like that of upright 3a in FIG. 4. Upright surfaces 25 adjacent to slot 9 on the rear side of rail sections 6 abut flange 19, and ball member 21 closely fits within the internal space 8. Preferably, neck 20 closely fits within slot 9 also. Thus, uprights 3 can rotate about their respective axes 24 if their lower ends are separated from ground anchor 5, but are retained in connection with rail assembly 2 until unless they rotate a full 90 degrees to the position of upright 3b. The upper end fitting 10 helps ease the assembly of barrier fence 1 as uprights 3 can be simply slotted into rail assembly 2 and rotated into position for connection to ground anchors 5.

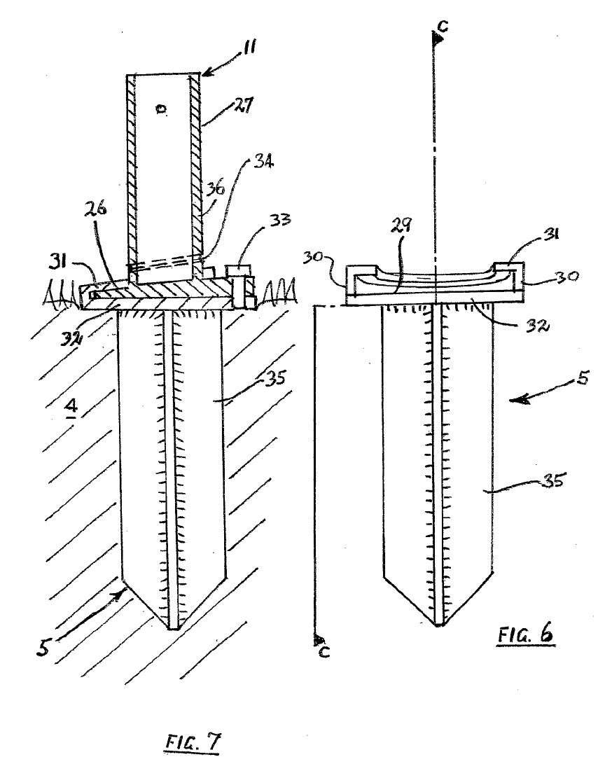

The method by which uprights 3 are secured to the ground 4 will now be described, by reference particularly to FIGS. 3, 5, 6 and 7. Fitting 11 comprises a tapered, foot-shaped body 26 and an upstanding tubular stub 27 which in use is received close-fittingly in the lower end of tube 12, and secured there by a pin 28. Instead of or in addition to pin 28, adhesive may be used, or simply a close fit to ensure that stub 27 stays fixed in tube 12. Stub 27 has a groove 34 extending around its circumference and partway through the wail 36 of stub 27. Fitting 11 may be a fabricated component or may be integrally formed as a single item, for example by die casting in a suitable metallic material or by injection moulding in a suitable plastics material.

Foot 26 is able to be slid into a space 29 defined by sidewalls 30, a top plate 31 and a baseplate 32 of ground anchor 5, and be secured in that space by a pin 33 passing through holes in both body 26 and baseplate 32. Depending from baseplate 32 of ground anchor 5 is a spike 35 of cruciform cross-section that in use is driven into the ground 4 to the point where the baseplate 32 is close to the surface of ground 4.

When the barrier fence 1 is being erected, a ground anchor 5 is driven into ground 4 and the fitting 11 comprised in an upright 3 is entered into space 29 of ground anchor 5 and secured there by pin 33. Generally upright 3 will first have been secured to rail assembly 2, in the way described above. Referring to FIG. 4, it is to be noted that a non-zero angle 37 is shown between axis of symmetry 39 of foot 26 and the direction of the length of the barrier fence, represented by the arrow 38. It is thought that for the best performance under impacts (see below) this may be advantageous, but a zero value for angle 37 is by no means precluded.

Means by which adjacent pairs of rail sections 6 (for example 6a and 6b) are connected end-to-end by a connector assembly 7 will now be described. Refer to FIGS. 20 and 21. An internal member 40 is shaped to be close-fitting in the space 8 of rail sections 6a and 6b and is entered into the ends of sections 6a and 8b. An outer sleeve 41 is shaped to fit close-fittingly over the exterior of rail sections 6a and 6b and bolts 42 pass through the rear side of outer sleeve 41 and are threadably secured in internal member 40. The ends of outer sleeve 41 are shaped s as not to have sharp corners or edges on at least the front side of rail assembly 2, to avoid the risk of injury to horses. Connection assembly 7 is intended to tightly grip the ends of sections 6a and 6b to ensure they do not separate under normally expected impacts to barrier fence 1.

Other connection arrangements, described later, are possible and may be used if desired and if suitable to a particular application. For example, FIG. 22 shows a cross-sectional view, intended to be directly comparable with FIG. 21, of an alternative connection assembly 50. Assembly 50 comprises an internal member 51 that closely fits in the spaces 8 at the ends of rail sections 6 to be joined (eg 6a, 6b), an external clamp member 52 and bolts 53 securing clamp member 52 and internal member 51 together. Clamp 52 and internal member 51 are shaped to hold rail sections 6a and 6b tightly around internal member 51. The adjoining ends of sections 6a and 6b are rounded off or otherwise smoothed to avoid any sharp edge where they abut. Connection assembly 50 and matching rail sections can provide a rail assembly similar to rail assembly 2 but without the lack of smoothness due to external sleeves such as sleeve 41.

With suitable choices of materials and dimensions, barrier fence 1 as described above can deflect to a degree under likely impacts from horses and/or jockeys, is resilient so as to spring back to its original shape in cases of comparatively light impacts, and can under heavy and impact-type loads collapse locally in such a way as to limit the risk of injury to the horses and/or jockeys.

Under comparatively light impacts, the rail assembly 2 can locally bend away from an impacting horse or jockey without individual rail sections such as 6a and 6b separating from each other. This bending away is partly due to bending of the rail assembly 2 itself, and partly due to bending of the uprights 3 about their lower ends. In addition, the rail assembly 2 rises slightly as it bends, thus, it is believed, progressively increasing the tendency for a horse nudging rail assembly 2 to withdraw from the rail assembly 2.

If a jockey or horse happens to fall over the top of rail assembly 2, probably while still moving forward as well, the fact that the uprights 3 extend downwardly and rearwardly from points close behind the rail assembly 2 means that the chance of injury through contact with (or even impaling on) uprights 3 is less than it would be with uprights shaped as shown at 14 in FIG. 3.

Under sufficiently heavy lateral impact in the direction of arrow 15 in FIG. 3, the connection between upright 3 and the ground 4 may be broken, but with the upright(s) 3 involved remaining connected to rail assembly 2 and able to swing freely until and unless they swing through a substantial angle—far enough for ball members 21 to leave slot 9. Breaking under impact of the connection between an upright 3 and ground 4 can be in any of several ways. Firstly, pin 33 may be so proportioned as to act as a shear pin, allowing foot 26 to leave the space 29. The tapering of foot 26 and space 29 is believed to enhance the reliability of component 11 leaving ground anchor 5 in this way under impact conditions, by comparison to an untapered body 26 (although that is not to preclude the possibility of foot 26 being untapered). Either the upper or the lower surface of foot 26, or both, may be made sloping.

Secondly, stub 27 can be provided with a suitably proportioned groove 34 (or otherwise weakened) so as to break under impact loads, by tube 12 and an upper part of stub 27 separating from the foot part 26 of body 11. In either case, it will be noted that ground anchor 5 stays embedded in ground 4 and that after the lower portion of upright 3 carries away there is nothing that protrudes substantially above ground 4 and that could represent a hazard to a falling horse or jockey.

Providing both carrying-away mechanisms for separation of a part of the above-ground portion of barrier fence 1 from its ground anchors 5 is believed to be advantageous. For example breakage of stub 27 at groove 34 could be arranged to occur under a specified impact load applied directly to upright 3, with ejection of foot 26 from space 29 being arranged to occur under a specified (and different) impact load applied laterally to rail assembly 2. Thus the barrier fence 1 may be “tuned” by design to respond in predictable and different ways to different types of impact loads. The choice of orientation of ground anchors 5 (i.e. choosing the angle 37) or of the insert 64c used with ground anchor 60 (see below) can also enhance the degree of control of behaviour of barrier fence fence 1 under different types of impact loads.

Alternatively, and it is thought more easily, barrier fence 1 may be designed so that failure of shear pin 33 and ejection of foot 26 from space 29 occurs in response to impact loads applied directly to tube 12, with reliance being placed on failure of stub 27 at groove 34 for carrying away under excessive rearward loads applied to rail assembly 2. Note that plate 31 of ground anchor 5 holds down foot 26 and so resists the rotation of foot 26 that tends to occur in response to rearward loads applied to rail assembly 2. Groove 34 may be non-uniform in a peripheral direction around stub 27 so that breaking off of stub 27 is more likely in response to rearwardly directed loads applied to rail assembly 2.

The ground anchor 5, foot 26 and pin 33 are believed able to provide a useful difference in response to loads applied at the height of rail assembly 2 and loads applied lower down, to an upright 3, even without the provision of a separate failure mechanism. If a horizontal impact load is applied close to the lower end of an upright 3, in a direction having a component at least partially along direction 39, pin 33 can fail in shear at a certain value of the impact load. However, if an equal horizontal load is applied higher on upright 3, or on rail assembly 2, the effect at the base of upright 3 is to apply both a shear force to pin 33 and a torque to foot 26 that tends to force end 200 of foot 26 upward against the lower face of top plate 31. Friction between foot 26 and top plate 31 then tends to resist movement of foot 26 out of the space 29, adding to the shear resistance provided by pin 33. Thus, the lateral impact force at the top of upright 3 required to cause its lower end to separate from ground anchor 5 exceeds the lateral impact force required if the load is applied further down, or at the base of, upright 3.

This too is believed to be advantageous because it further assists design of the fence 1 to resist a certain degree of nudging of rail assembly 2 by horses, while allowing an upright 3 impacted lower down (for example by a jockey sliding under the rail assembly 2) to carry away and reduce the potential for injury.

This effect can be enhanced if desired by providing high-friction surfaces on either or both of the upper surface of foot 26 and the lower surface of top plate 31. These surfaces could for example have serrations (not shown).

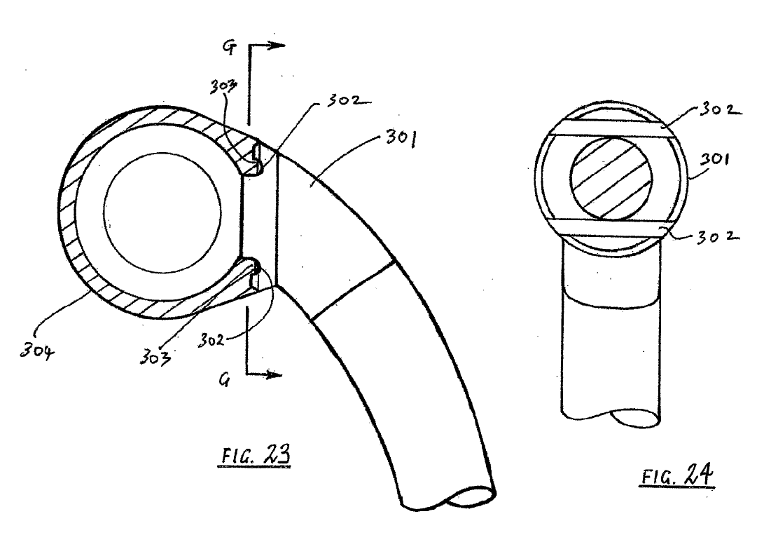

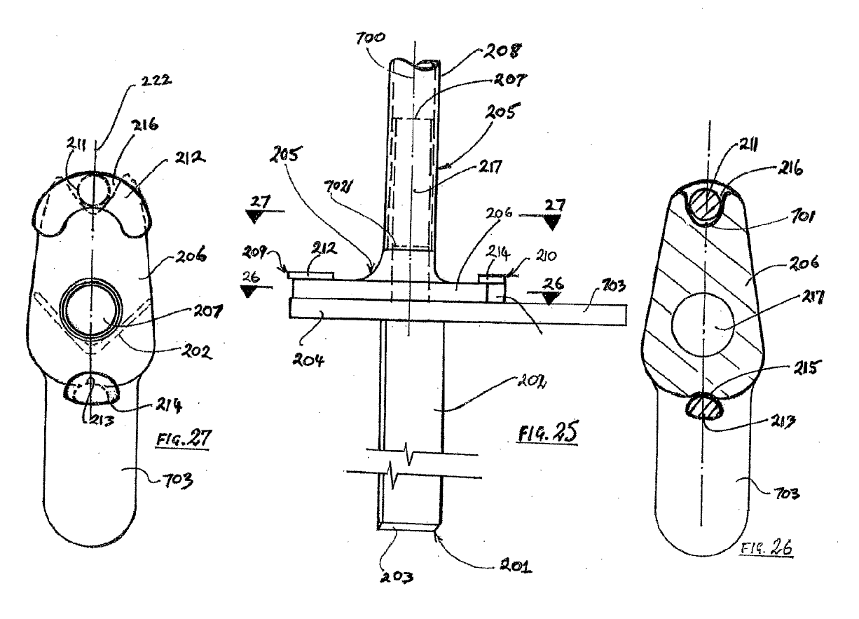

A variation is now described to the way in which the upper end of uprights 3 can be connected to rail assembly 2, by reference to FIGS. 23 and 24. Rather than having the upper end fittings (such as 10) on uprights (such as 3) able to rotate completely freely, they may be provided with a form of detent, whereby the upright has a preferred position, for example one in which the plane in which the uprights 3 lie is normal to the length of the rail assembly 2. This can be achieved with upright upper end fittings 301 that are similar to fittings 10 except for having grooves 302 that in the preferred or detent position receive elongate projections 303 on rail section 304. To avoid excessive-restraint against free rotation of fittings 301 in rail sections 304, it can be arranged that projections 303 do not fully fill grooves 302. It will be understood that an equivalent arrangement, not shown, in which the grooves are on the rail section and the projections are on the fittings, is also possible.

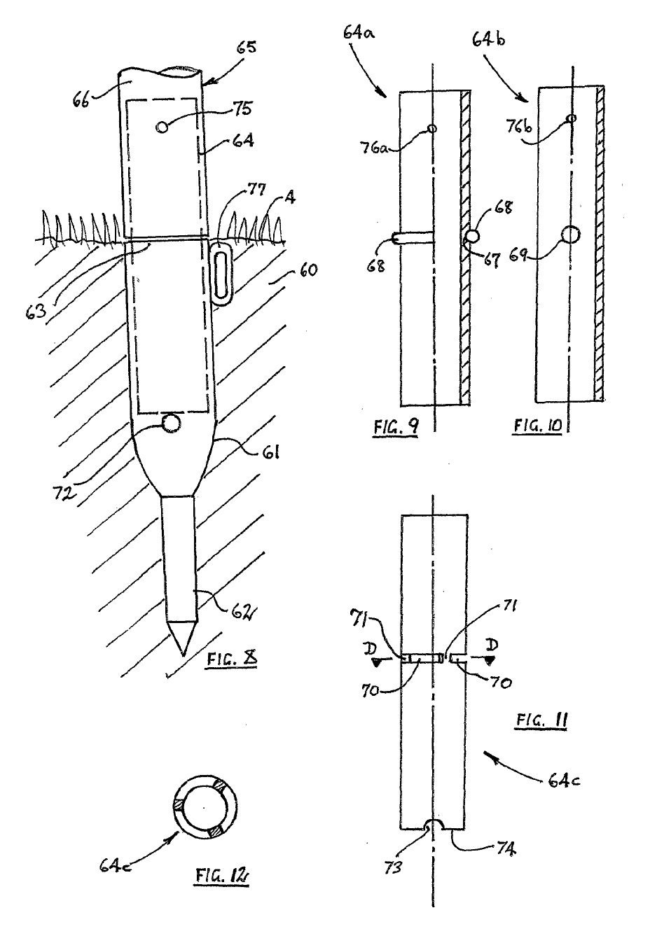

FIG. 8 shows a ground anchor assembly 60 that is an alternative to ground anchor 5. Assembly 60 comprises firstly a tubular in-ground member 61 with a pointed bottom section 62 to facilitate driving into the ground 4 until upper rim 63 is approximately level with the surface of ground 4. Secondly, assembly 60 comprises an insert 64 that is tubular and fits closely into member 61. An upright 65 comprises a tube 66 (essentially the same as tube 12 of upright 3) but without fitting 11. Instead, the lower end of tube 66 simply fits closely over insert 64 where it extends above ground level. Under lateral impact loads, the connection between upright 65 and ground anchor 60 can be broken in any of several ways. In one of these, insert 64 may simply bend sideways until tube 66 pulls longitudinally off the upper part of insert 64 or insert 64 is pulled out of member 61. In another, insert 64 may be locally weakened to fail (eg by shearing off) close to ground level. FIGS. 9-12 show three possible versions of insert 64 that achieve this. Tubular insert 64a (FIG. 9) has a circumferential groove 67 to define a breakage area. An O-ring 68 may optionally be placed in groove 67 to lodge inside the tubular upper part of anchor 61 and also limit water draining into the lower part of anchor 61.

FIG. 10 shows an alternative tubular insert 64b in which weakening near ground level is provided by a simple through-hole 69.

FIGS. 11 and 12 show another alternative insert 64c in which weakening near ground level is provided by part-circumferential cutouts 70 leaving connecting stems 71. Tubular member 61 has a fixed rod 72 extending diametrically therethrough, and insert 64c has a recess 73 in its lower edge 74 that fits over rod 72 so as to control the orientation of the cutouts 70 and stems 71. In this way, it is possible to control the direction in which breakage of insert 64c is most likely to occur.

Insert 64 (or 64a, 64b or 64c) may be pinned to tube 66 by a pin 75 passing through a hole 76 (or 76a, 76b, or 76c). A ring member 77 is provided on member 61 to facilitate withdrawal from ground 4 if required for example during relocation of the barrier fence.

It is of course possible to provide a ground anchor (not shown) that has a below-ground part similar to (or the same as) the ground anchor 60, but with an upper portion functionally the same as that of ground anchor 5.

FIG. 16 is a cross-sectional view of a rail section 80 that is an alternative to the section 6, and an upper portion of an upright 81 that is an alternative to upright 3. Rail section 80 has an internal space 82 and a slot 83 along its length (respectively equivalent to space 8 and slot 9 of section 6). Upright 81 includes a fitting 84 secured within the upper end of a tube 85 (like tube 12), that in turn includes a connecting member 90 passing through slot 83 and a plate-like part 86 that fits closely within space 82. As shown in FIG. 17, part 86 is in the form of a disc. If the lower end (not shown) of upright 81 separates from its ground anchor (not shown) this arrangement permits upright 81 to rotate about an axis 87 without separating from rail section 80. If required, fitting 84 can be secured to tube 85 by a shear pin 88 so that even tube 85 and fitting 84 can separate under impact.

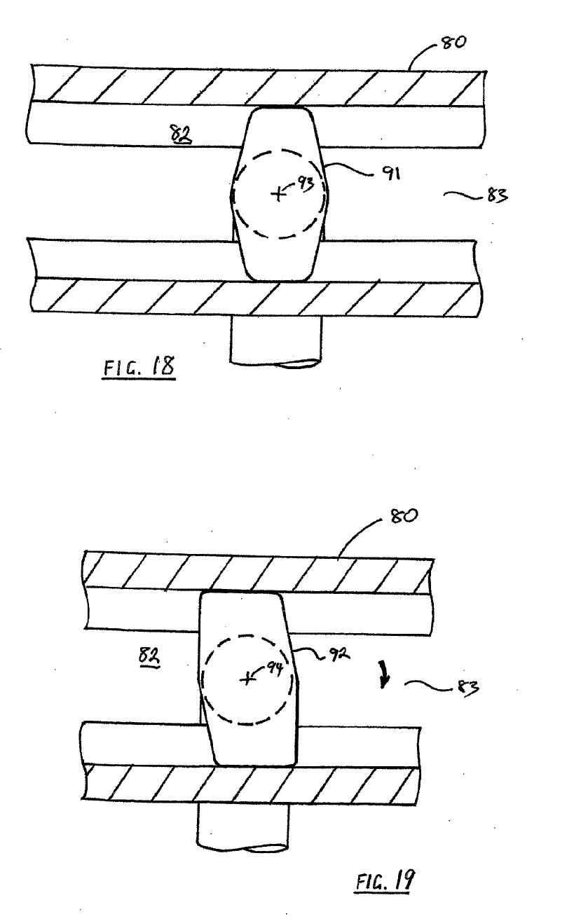

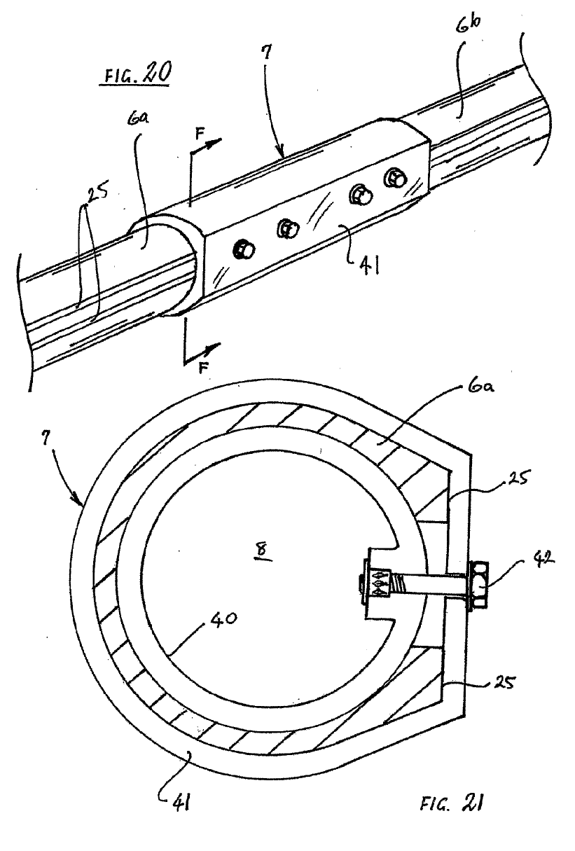

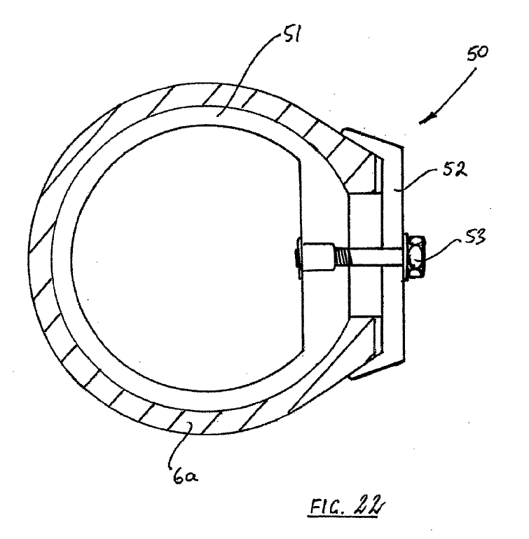

Possible modifications of the arrangement of FIGS. 15 and 16 are shown in FIGS. 18 and 19. These differ from the arrangement of FIGS. 15 and 16 only in the shape of the plate-like members 91 and 92 that are alternatives to plate-like member 86. Members 91 and 92 are shaped and sized so that in a particular orientation about their respective axes 93 and 94, they can be pushed in through slot 83 (like ball member 21 of upright 3) without having to be fed in through the end of rail section 80, and then rotated into the operative positions shown. By suitable control of the shape of members 91 and 92 and their clearance in space 82 it is possible to control the torque required to make members 91 and 92 rotate about axes 93, 94, further enhancing the degree to which the behaviour of a barrier fence under impact loads can be controlled.

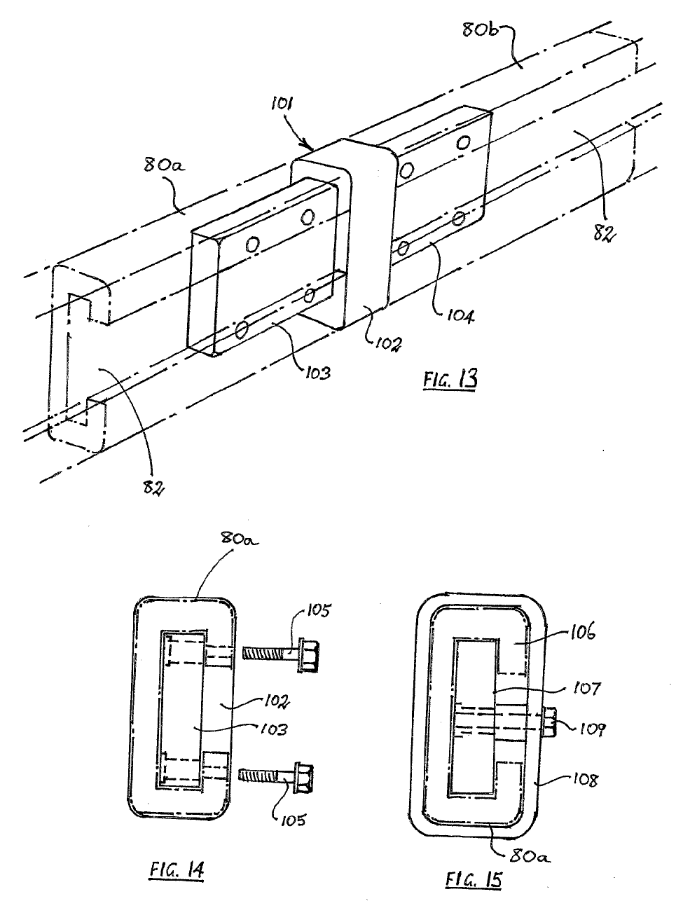

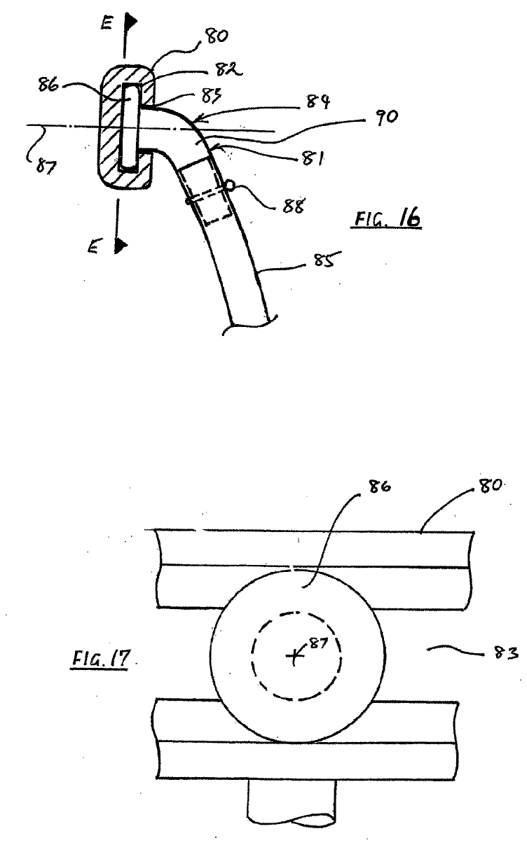

FIGS. 13 and 14 show an alternative connection assembly 100, as applied to the end-to-end connection of rail sections 80a and 80b (the same as section 80). A member 101 has firstly a central section 102 that is sized and shaped (when seen end-on as in FIG. 14) similarly to the cross-section of rail sections 80a, 80b and secondly tangs 103 and 104 that extend lengthwise in opposite directions and are shaped and sized to snugly enter spaces 82 of sections 80a, 80b. Bolts 105 pass through sections 80a and 80b and into tangs 103 and 104, thus connecting rail sections 80a and 80b while ensuring that the upper lower and front sides of the assembly of sections 80a, 80b and 101 are of constant cross-section.

A modification of this arrangement is shown in FIG. 15 which is from a similar viewpoint as FIG. 14. In this arrangement, a connecting member 106 is provided that is the same as member 101 except that threaded bolt holes are provided in tangs 107 (equivalent to tangs 103, 104) in a different position. An external sleeve 108 close-fittingly surrounds rail sections 80a and 80b and member 106 and is bolted to tangs 107. (Although not shown, sections 80a and 80b may also be bolted to tangs 107.)

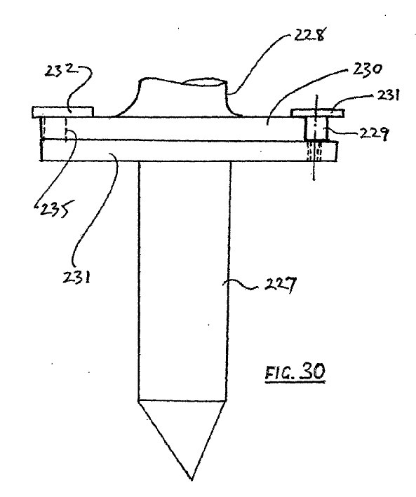

There will now be described a further barrier fence 218 that is different from and is preferred over barrier fence 1. Refer to FIG. 28. Barrier fence 218 has a continuous elongate rail assembly 219 (corresponding to rail assembly 2 of barrier fence 1 and formed of lengths of rail joined end to end as for barrier fence 1) supported by uprights 220 (corresponding to uprights 3 of barrier fence 1) and has ground anchors 201 (corresponding to ground anchors 5 of barrier fence 1).

FIG. 28 shows in plan view a portion of barrier fence 218 comprising rail assembly 219 and an upright 220 secured to rail assembly 2 in the same way as in barrier fence 1 upright 3 is secured to rail assembly 2. The bottom end of an arcuately bent tube 221 (like tube 12) of upright 220 is received on stub 207 of a fitting 205, and fitting 205 is mounted to a ground anchor 201 that is described below. Line 222 lies in the plane that contains the axis of tube 221 and so is normal to the length of rail assembly 219.

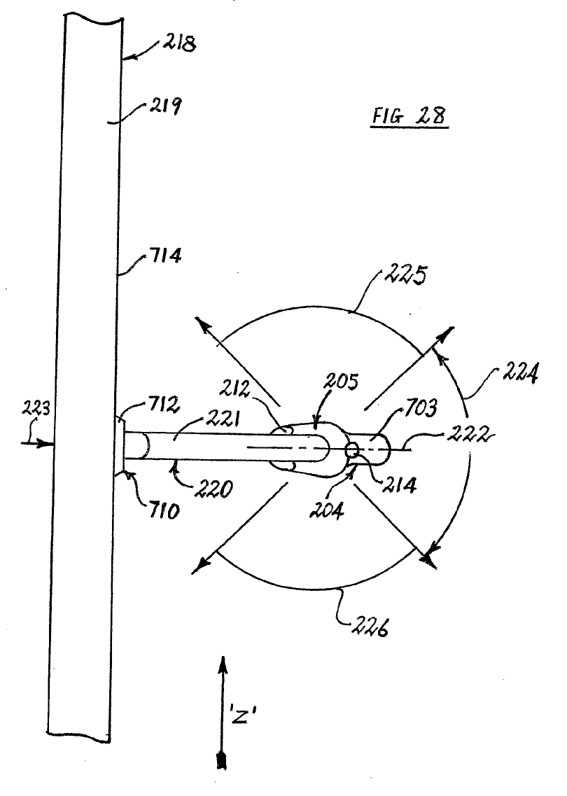

FIG. 25 shows a ground anchor assembly 201 having a lower section 202, with sharpened lower edge 203 that is adapted to be driven into the ground, and a top plate 204. Lower section 202 may be of any suitable cross-sectional shape and is shown (see phantom lines in FIG. 27 only) as being formed of hot-rolled steel equal angle in an orientation that enhances the resistance of ground anchor to overturning in the ground under rearwardly directed sideloads applied to rail assembly 219. Anchor 201 is able to be driven into the ground (not shown) in a similar manner to ground anchors 5 and 61, so that plate 204 is close to, approximately flush with or bearing against, the ground surface.

Secured to ground anchor 201 is a bottom fitting 205. The breakaway mechanism provided by ground anchors 201 and fittings 205 constitutes an important difference between barrier fence 218 and barrier fence 1. Fitting 205 has a plate 206 that in use sits above and bears against plate 204, and an upstanding stub 207 that fits into a lower end of a tubular upright member 208 (similar to tube 12). Fitting 205 has an optional hole 217 extending through it, coaxially with stub 207. Plate 206 is held in place by two formations 209 and 210 that are secured to top plate 204.

Also to enhance the resistance of ground anchor 201 to overturning in the ground under rearwardly directed sideloads applied to rail assembly 219, plate 204 has a rearwardly directed extension 703 whose lower surface abuts the ground.

Formation 209 has an upstanding pin 211 and a plate 212 that is secured to an upper end of pin 211. Plate 206 fits snugly between plates 212 and 204. Pin 211 is “matingly” received in a recess 216 in plate 206. The word “matingly” as used here is described below. Formation 210 has an upstanding pin 213 and a plate 214 that is secured to an upper end of pin 213. Plate 206 also fits snugly between plates 204 and 214. Plate 206 has a shallow recess (dimple) 215 that is shaped to matingly accommodate a portion of pin 213. The shapes and proportions of pins 211 and 213, recess 216 and dimple 215 are such that plate 206 is held snap-fittingly by and between pins 211 and 213 with substantially no free play, but such that plate 206 can be dislodged by urging it with a comparatively small force in a direction perpendicular to a line 222 between pins 211 and 213, compared to the large force which would be required to move plate 206 along line 222.

Turning to use of the word “matingly” above, it will be noted that where pin 211 is received in recess 216, there is a clearance 701 on centerline 222 so that pin 211 bears against only the sides of recess 216. This is to ensure that when plate 206 is pushed into place between pins 211 and 213, plate 206 is slightly under compression. This has been found desirable to enhance the snap-fitting retention and subsequent release of plate 206 between pins 211 and 213.

It has also been found desirable that tube 221 be able to rotate about the longitudinal axis 700 of stub 7. This aids in positioning plate 206 in engagement with ground anchor 201 and in obtaining its satisfactory release also.

In response to a horizontal load (represented by vector 223) applied in a rearward direction to the rail assembly 219, tube 221 bends as required, but plate 206 of fitting 205 is held very securely between pins 211 and 213 and between plates 204 and both 212 and 214. Vector 223 is representative of a load that might be applied by a horse nudging rail assembly 219 for example. Plate 212 acts to prevent rotation of plate 206 under such loads 223, as plate 206 is urged upwardly against, plate 212 under such loads.

However, a horizontal load 227 applied directly to upright 220 or fitting 205, for example by a jockey falling underneath rail assembly 219 has an effect that depends on the direction of the impact. It has been found that if such a load is in the direction of line 222 (as seen in FIG. 28) or within a certain angular range (represented by arrow 224) that includes line 222 and extends on either side of line 222, then fitting 205 will remain in place. But if the horizontal load on upright 220 is directed within either of the ranges represented by arrows 225 and 226, it has been found that fitting 205 will slide off ground anchor 201, so minimizing the chance of injury to the jockey. The ranges 224, 225 and 226 can be influenced by the design of fitting 205 and ground anchor 201.

Thus, barrier fence 218 can be designed to be very secure against actual carrying away of lower ends of uprights 220 in response to likely loads on rail assembly 219, but with those lower ends being able to carry away under loads applied to uprights 220 for example by riders (or horses) falling underneath rail assembly 219. It will be noted that the presence of both ranges 225 and 226 allows racing in both directions along fence assembly 218. (On the other hand, there is no necessity for line 222 to be perpendicular to the length of rail assembly 219, and a different orientation may be preferable if racing is normally in one direction only.

Instead of dimple 215, plate 206 could have other types of formation to engage pin 213.

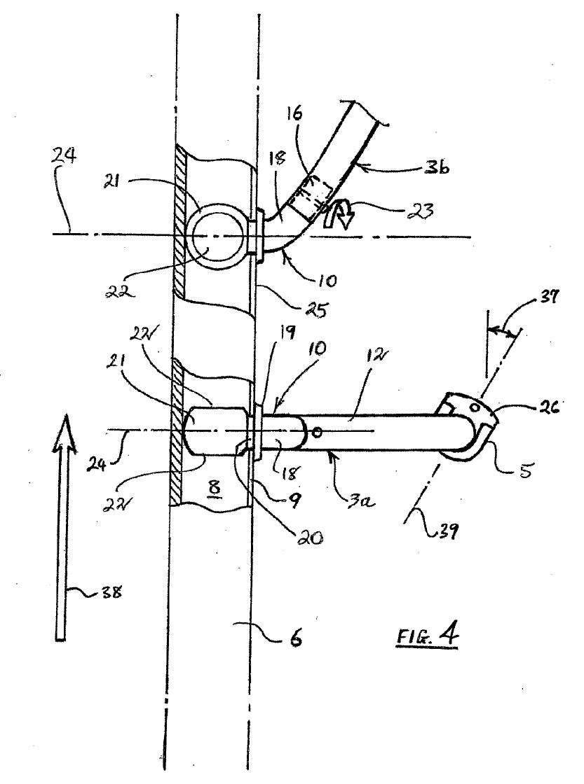

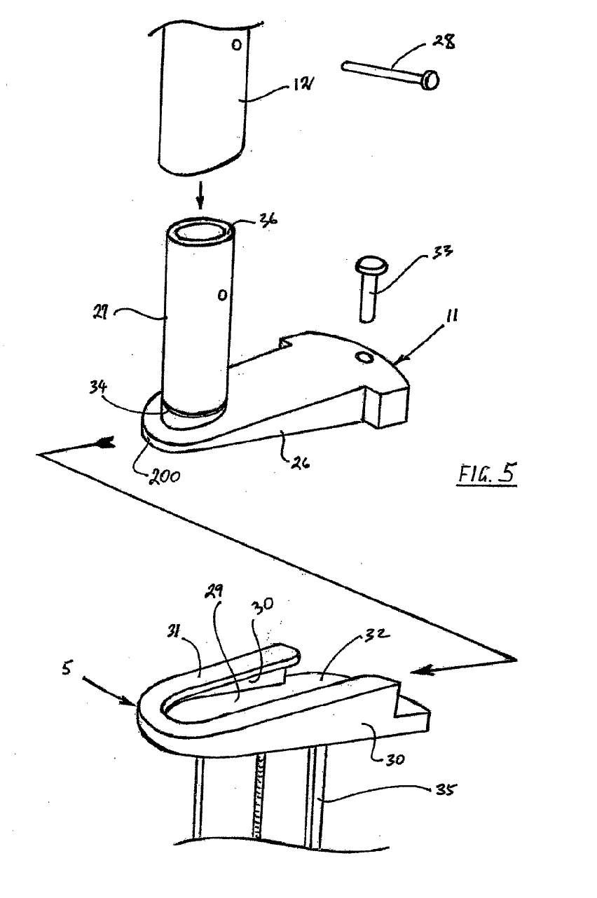

Note that the junction between stub 207 and plate 206 may be filleted as shown, optionally including having a larger radius fillet facing plate 212 and a smaller radius fillet facing plate 214 to avoid stub 217 itself failing there under impact loads. Measures such as those described above by reference to FIGS. 5 (item 34) and 9-11 are preferably provided to enable predictable carrying away under loads not applied to upright 220 in the angle ranges 225 or 226. As a specific example, a groove 702 may be provide at the base of stub 207 as a “weak point” so that under large side loads applied rearwardly (as load 223) to rail assembly 219 it is possible for tube 221 and stub 207 of the upright 220 to separate from fitting 205 and ground anchor 201. The load 223 at which this occurs can be chosen quite independently of the impact load on upright 220 at which plate 206 is released from between pins 211 and 213, an advantageous feature.

It is desirable if stub 207 does break that it be retained in the lower end of tube 221 to avoid becoming hazardous to riders or horses. Although not shown, it is possible to provide for this. For example a pin or screw could be arranged to pass through one wall of tube 221 with an end of the pin or screw being received in another groove in stub 207 so as to prevent lengthwise movement of stub 207 in tube 221.

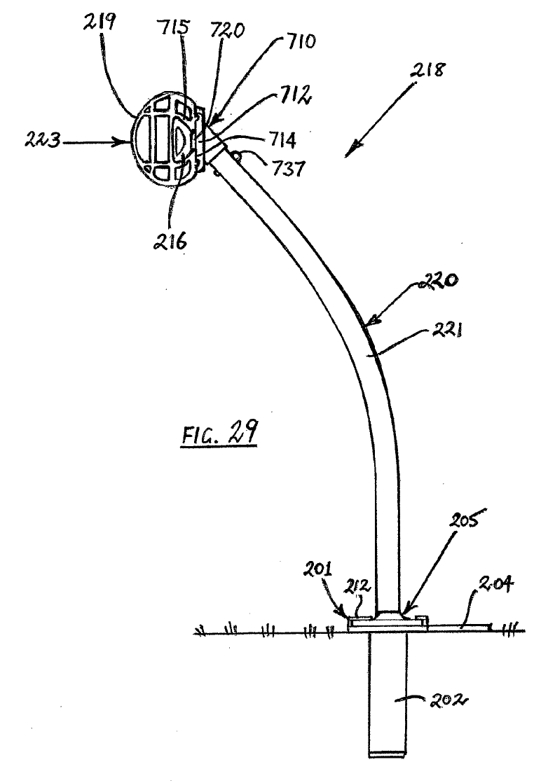

FIG. 30 shows a modified version of the arrangement (ground anchor 201 and fitting 205) shown in FIGS. 25-29 that can also allow carrying away under loads applied in the angle range 224. Ground anchor 227 is essentially the same as ground anchor 201 and fitting 228 is the same as fitting 205, except that instead of formation 210 there is provided a shear pin 229 that is secured to (for example by threadably engaging) plate 231 (equivalent to plate 204) and that in normal-use plays the role of pin 213. This includes the manner of holding plate 230 (equivalent to plate 206) between pin 229 and pin 235 (equivalent to pin 211). Pin 229 has a head 231 that in normal use acts the same as plate 214. However, in response to a sufficiently high horizontal load applied to fitting 228 or tube 221 in the angle range 224, shear pin 229 can fail so that fitting 228 can slide off ground anchor 227. Thus the range of angles within which a jockey or horse can impact an upright 220 and expect it to carry away can be extended. As in the case of the arrangement shown in FIGS. 5-7, a difference in response to loads applied at the height of rail assembly 219 and loads applied to upright 220 or fitting 228 can be secured by suitable design (including the optional use of a roughened upper surface on plate 230 and/or a roughened lower surface on plate 232 (equivalent to plate 212). Plate 230 could even be tapered like foot 26.

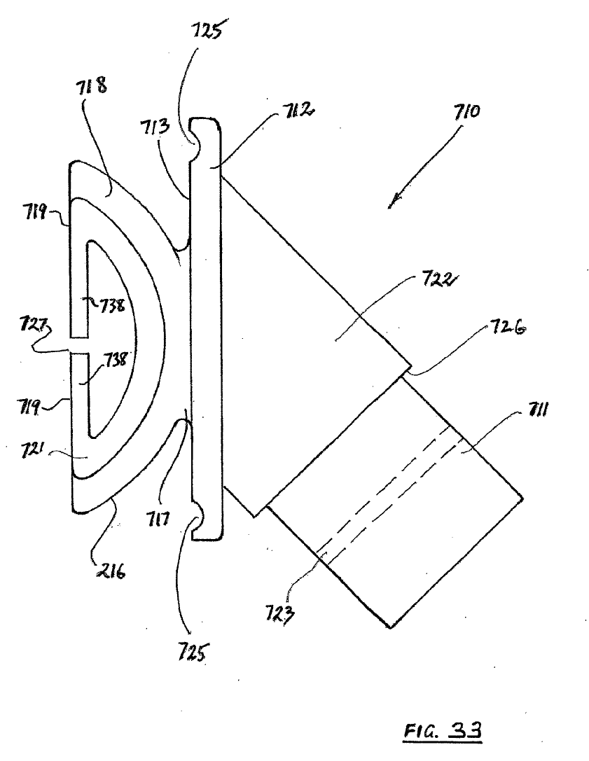

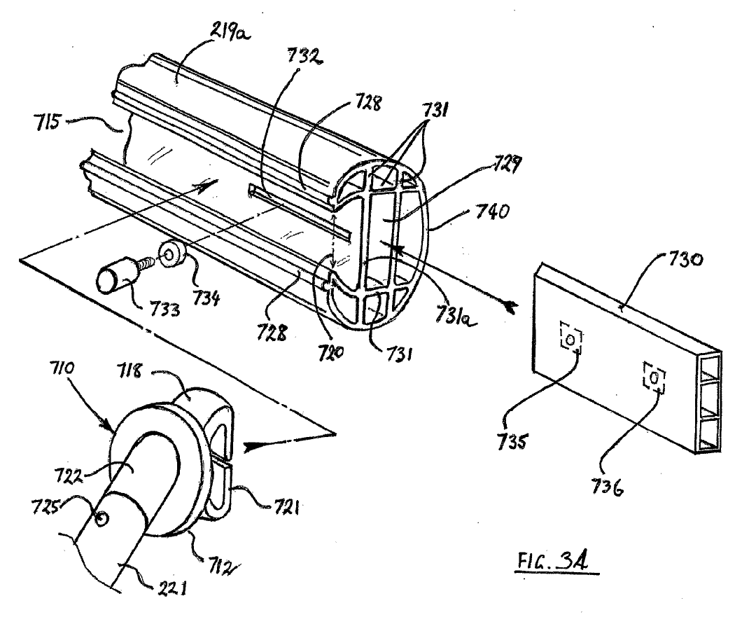

Barrier fence 218 has another difference from barrier fence 1 in the arrangement at the upper end of its uprights 220, which will now be described. Referring to FIGS. 29, 33 and 34, it will be seen that the upper end of tube 221 is secured on a stub 711 of an upper end fitting 710. Fitting 710 has a flange 712 with a forward-facing surface 713 that abuts a rearward facing surface 714 of rail assembly 219. Close-fittingly received in an internal space 715 of rail assembly 219 is a formation 216. Formation 216 is connected to flange 712 by a neck 717 and has a part-spherical surface 718 and flat surfaces 719 that abut matching surfaces defining the boundary (in transverse cross-section) of space 715. Surfaces 719 are on formations 738 and there is a gap 727 between formations 738. This is so that the portion of fitting 710 that lies within space 715 can be so made (for example by injection moulding in plastics) as to spring outward against the inner surfaces of space 715. Neck 717 is received in a slot 720 that extends along rail assembly 219 and connects internal space 715 to the exterior of rail assembly 219. Formation 216 has parallel end faces 721 that are so spaced apart as to enable formation 216 to be entered into internal space 715 through slot 720 when upright 220 is rotated to a horizontal position. However, when upright 220 is rotated downwardly to the position shown in FIG. 29, the fitting 710 is captive in rail assembly 219, although able to rotate about a horizontal axis if the lower end of upright 220 breaks away as described above.

Parallel grooves 725 are formed in surface 713 of flange 712. Their purpose is to act as part of a detent mechanism as described above by reference to FIGS. 23 and 24. FIG. 34 shows raised elongate formations on rail assembly 219 that mate with grooves 725.

Fitting 710 has the advantage over fittings such as fitting 10 of being smaller and requiring less material.

Stub 711 is an extension of a transition piece 722 that has a shoulder 726 for the upper end of tube 221. A hole 723 is provided through stub 711 for a pin 737 (FIG. 29) whereby fitting 710 is locked to tube 221.

Note that stub 711 (hence tube 221) extends rearwardly and downwardly at a substantial angle (shown as about 45 degrees but preferably between about 40 degrees and about 60 degrees) below the horizontal and that stub 711 and transition piece 722 are very close to flange 712. These factors together with the smooth arcuate shape of tube 221 contribute to upright 220 presenting a comparatively small hazard to falling riders.

Tube 221 is shown as (and preferred to be) bent into a smooth arcuate shape (in a plane transverse to rail assembly 219) between stubs 711 and 207. The section between stubs 211 and 207 may be of substantially constant radius of curvature. Tube 221 is however straight where it is received on stubs 207 and 211.

FIG. 34 shows a portion of barrier fence 218 at an end of one 219a of the multiple rail lengths that are joined end to end to form rail assembly 219. Rail length 219a is shown as an extrusion of constant cross-section having partitions 731 within a peripheral cover 740. Such a construction is known in the barrier fence art. Fitting 710 can be entered into and made captive in internal space 715 of rail length 219a either by orienting fitting 710 so that formation 216 can pass through elongate slot 720 and then rotating to the position shown in FIGS. 29 and 34, or by being moved lengthwise into space 15 if an end of rail length 219a is accessible.

Also shown in FIG. 34 is a way of joining rail lengths such as 219a end to end that is additional to those described above by reference to FIGS. 2, 13, 14, 20, 21 and 22 and convenient when barrier fence 218 is being assembled. A movable elongate body 730 can be entered partly into a space 729 of rail length 219a, and partly into a corresponding space of another such rail length (not shown) to join the rail lengths end to end. A bolt 733 can be passed through a slot 732 and engage in a captive nut 735 in body 730. When bolt 733 is tightened, body 730 is held tightly against partition 731a between nut 735 and a washer 734 on bolt 733. Another captive nut 736 is provided in body 730 and can be used with a bolt (not shown) like bolt 733 to firmly hold another rail length to length 219a, i.e. with no capacity for lengthwise relative movement between them. Alternatively at a joint between two rail lengths made with body 730, one can use only one of the captive nuts 735 and 736, so that relative longitudinal movement is possible to accommodate for example thermal expansion. Thus it is readily possible to provide a rail assembly 219 that consists of groups of individual rail lengths such as 219a joined together rigidly, with expansion able to be accommodated between these groups.

Note that a joint of the type shown in FIG. 34 between adjoining rail lengths such as 219a can be easily unmade, by sliding body 730 fully into one of the rail lengths 219a (with bolt 733 sliding along slot 732) so that the other is released.

Although not shown in FIG. 34, a close fitting external sleeve (analogous to those shown in FIGS. 2 and 20-22 may be secured over the end of rail length 219a to cover the actual ends between adjoining rail length ends and any gap between them, so that the rail assembly 219 appears continuous and externally smooth.

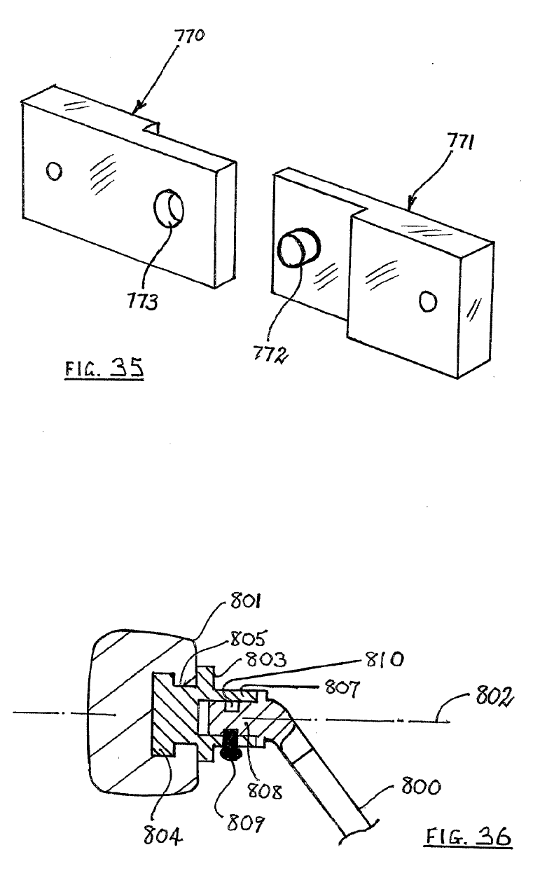

As an alternative to body 730, FIG. 35 shows a two interlocking parts 770 and 771 that can do essentially the same thing. Body 770 can be entered slideably into space 729 in a right hand end of rail length 219a and (like body 730 in FIG. 34) be retained there by bolt 733 which slides in slot 732 and can be received in a threaded hole 774. Similarly, body 771 can be entered into the corresponding space at a left hand end of a rail length (not shown) to be connected to rail length 219a, and slid lengthwise or secured by a bolt in the same way. Body 771 has a boss 772 that can be close fittingly received in a hole 773 in body 770 to prevent longitudinal relative movement of the bodies 770 and 771. When the two bodies 770 and 771 are thus connected, withdrawn into their respective rail lengths and secured by bolting, the two rail lengths are held together.

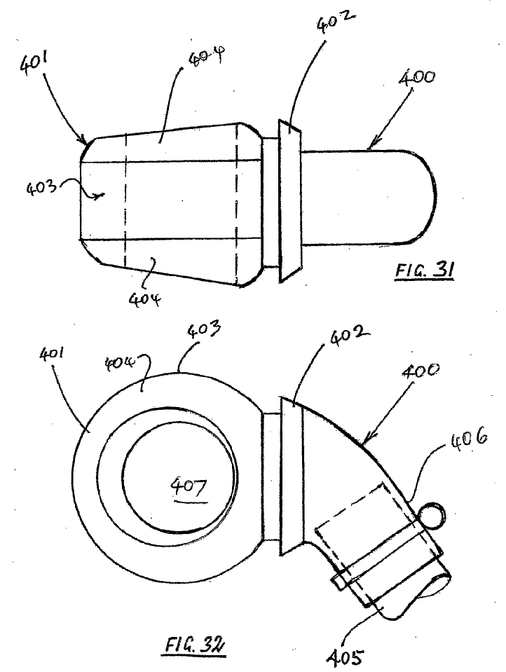

Yet another upright upper end fitting 400, shown in FIGS. 31 and 32, is now described, that is an alternative to such fittings as 10, 301, 84 and 710. Fitting 400 is used in essentially the same way as fitting 10 (for example) and does what that fitting does, as described above. It has a part 401 (corresponding to ball member 21) that is received in a rail (like rail 6, not shown), and a flange 402 (corresponding to flange 19) that bears against the rear of that rail. It differs from fitting 10 in the following respects:
(a) Part 401 has a cylindrical surface 403 and curved surfaces 404, the surface 403 lying against the internal surface of the rail in normal use. During placement of fitting 400 and an attached upright (not shown) into a rail, and in the event of a lower end of the upright carrying away from its ground anchor, so that part 401 must rotate within the rail, surfaces 404 can bear against the internal surface of the rail just as the surface of member 21 does. The presence of surface 403 provides another form of “detent” action, so that member 400 tends to “snap” into a preferred orientation in the rail.
(b) Part 401 is tapered, becoming wider as shown in plan view from its front side to its rear (flange) side. This provides a “snap in” action when fitting 400 is fitted into the rail, and helps limit any tendency of fitting 400 to pop out of the rail in the event of large rotations of fitting 400. (Compare with FIG. 3, plan view of 10.)
(c) Fitting 400 has a female sleeve section 406 to receive upright tube 405 rather than a male stub that extends into tube 405.

FIG. 36 shows an alternative way of providing for an upright 800 to be secured to a rail assembly 801 (seen in transverse section) and for its upper end to be able to rotate about a horizontal axis 802 if the lower end (not shown) of upright 800 breaks away. A fitting 803 (seen in section) has a section 804 that is retained in a space in rail assembly 801 and extends out through a slot 805. An outer section of fitting 803 comprises a short tubular section 807, in which a stub axle 808 secured to an upper end of upright 800 is received and can rotate about the axis 802. A pin 809 in a wall of tubular section 807 is received in a peripheral groove 810 in stub axle 808 to retain stub axle 808 within tubular section 807. This arrangement is believed more difficult to make compact (and so less harmful in the event of a rider falling from above) than the other arrangements described herein.

Barrier fences according to the invention may be constructed using any suitable materials. The following are non-limiting examples. For rails (eg 2, 219), extrusions in plastics such as PVC have been found suitable. For tubing to be used in uprights (eg tubes 12, 221), PVC (especially) and polycarbonate plastics have been found suitable. For uprights upper and lower end fittings and rail joining components, plastics materials such as HDPE have been found suitable. Steel has been found suitable for ground anchors.

Still other variations may be made that do not exceed the scope of the present invention.

1. A barrier fence comprising an elongate rail and uprights secured thereto at positions along the rail, wherein an upright is secured at an upper end to the rail and at a lower end to a ground anchor offset transversely in a rearward direction from a position below the rail and wherein the lower end of the upright is adapted to separate from its associated ground anchor in response to an impact load on the upright that has a component directed horizontally and in a direction parallel to the rail.

2. A barrier fence according to claim 1 wherein the lower end of the upright and the ground anchor are configured to in use resist separation of the lower end of the upright from the ground anchor in response to horizontal loads applied transversely to the rail in the rearward direction.

3. A barrier fence according to claim 2 wherein:
(a) the lower end of the upright comprises a foot member protruding laterally outward and of which a portion is urged upwardly in response to horizontal loads applied transversely to the rail in the rearward direction; and
(b) the ground anchor comprises a formation that at least partially overlies the upwardly urged portion of the foot member so as to resist upward movement thereof.

4. A barrier fence according to claim 3 wherein a frangible component connecting the lower end of the upright to the ground anchor is arranged to be broken under a specified minimum value of said impact load on the upright so that the lower end of the upright separates from the ground anchor.

5. A barrier fence according to claim 3 wherein the foot member is snap fittingly held between first and second upright formations comprised in the ground anchor and is releasable in response to the said impact load on the upright.

6. A barrier fence according to claim 5 wherein when the foot member is snap fittingly received between the upright formations the first said upright formation is received in an inwardly tapering recess formed in an edge of the foot member and presses against the foot member on opposing sides of the recess.

7. A barrier fence according to claim 5 wherein the first and second upright formations lie at least approximately in a plane transverse to the length of the rail so that the foot member is releasable in either of two opposite directions each corresponding to one of two possible directions of the said impact load component.

8. A barrier fence according to claim 5 wherein the formation that overlies part of the foot member is secured to one of said upright formations.

9. A barrier fence according to claim 8 wherein the formation that overlies part of the foot member is secured to the first upright formation.

10. A barrier fence according to claim 5 wherein the foot member in use is supported by an upwardly facing surface of the ground anchor.

11. A barrier fence according to claim 3 wherein the foot member is rotatable about an axis that extends lengthwise in the lower end of the upright.

12. A barrier fence according to claim 3 wherein the upright comprises a length of tubing and a lower end fitting secured to a lower end of the tubing and wherein the foot member is comprised in the lower end fitting.

13. A barrier fence according to claim 1 wherein at a position above and adjacent to lower end of the upright, the upright is adapted to separate into two portions in response to loads applied to the rail or the upright that due to direction or magnitude do not cause separation of the lower end of the upright from the ground anchor.

14. A barrier fence according to claim 13 wherein:
(a) the upright comprises a length of tubing and a lower end fitting secured to a lower end of the tubing;
(b) the lower end fitting comprises an upstanding stub that is received in a lower end of the tubing;
(c) the stub has a frangible portion that by failing enables said separation into two portions of the upright.

15. A barrier fence according to claim 1 wherein the upper end of the upright is secured pivotally to the rail so that on separation of the lower end of the upright from the ground anchor the upright is free to pivot through an angular range without separating from the rail.

16. A barrier fence according to claim 15 wherein said pivoting of the upright on separation of its lower end is about an axis that lies approximately in a plane transverse to the rail.

17. A barrier fence according to claim 15 wherein said pivoting of the upright on separation of its lower end is about an approximately horizontal axis.

18. A barrier fence according to claim 15 comprising detent means at the pivot connection between the upright and the rail whereby pivoting of the upright away from the position relative to the rail that it would occupy when secured to the ground anchor requires application to the upright of a greater torque than subsequent pivoting within the angular range.

19. A barrier fence according to claim 18 wherein one of the upright and the rail comprises a male formation and the other of the upright and the rail comprises a female formation and wherein the male formation is receivable in the female formation so as to provide the detent means.

20. A barrier fence according to claim 19 wherein the upright has a flange that abuts an external surface of the rail and the flange has one of the male and the female formations formed thereon.

21. A barrier fence according to claim 15 wherein the upright comprises an upper end formation that is received and can rotate within an internal space in the rail and that is connected to that part of the upright outside said space by a neck passing through an opening in the rail, the space and the rail being so shaped that the upper end formation is captive in the internal space when the upright is secured to the ground anchor and when the upright is pivoted to any point in the angular range.

22. A barrier fence according to claim 21 wherein the upper end formation has a surface that is a portion of a male spherical surface and the internal space extends lengthwise in the rail and when seen in cross-section transverse to the rail has a mating female circular surface so as to permit rotation of the upper end formation about the axis.

23. A barrier fence according to claim 22 wherein a further surface of the upper end formation is substantially flat and abuts a substantially flat internal surface of the internal space.

24. A barrier fence according to claim 21 wherein a surface of the upper end formation is a cylindrical surface that slidingly mates with an internal surface of the internal space so as to permit rotation of the upper end formation about the axis.

25. A barrier fence according to claim 21 wherein the upper end formation comprises a cam that is shaped to hold the upright in a specified position and to permit rotation of the upright away from the specified position on application of a specified minimum torque.

26. A barrier fence according to claim 21 wherein the upper end formation is so shaped as to be able to be passed through the said opening in the rail and received in the internal space when the upright is in a specified angular position about the said axis and thereafter rotated about the said axis into the said angular range.

27. A barrier fence according to claim 26 wherein the opening into the internal space in the rail is a slot extending lengthwise of the rail and the upper end formation is shaped to be able to pass between upper and lower boundaries of that slot in a particular angular position of the upright.

28. A barrier fence according to claim 27 wherein in the said particular angular position the upright is rotated approximately 90 degrees about the said axis from its position when secured to the ground anchor.

29. A barrier fence according to claim 21 wherein:
(a) the upright comprises a length of tubing and an upper end fitting secured to an upper end of the tubing;
(b) the upper end fitting comprises the neck, the upper end formation and a stub that is received and secured in the upper end of the tubing.

30. A barrier fence according to claim 29 wherein the upper end fitting includes a flange that abuts an external rearwardly facing surface of the rail both above and below the neck.

31. A barrier fence according to claim 30 wherein the upper end fitting has a stub extending from a rear face of the flange a portion of the stub being received in the upper end of the tubing and wherein when the fence is erected on a horizontal surface a longitudinal axis of the stub extends rearwardly and downwardly from the flange rear face at an angle below the horizontal of at least 40 degrees and preferably between about 40 and about 60 degrees.

32. A barrier fence according to claim 1 wherein the upright comprises:
(a) a length of tubing;
(b) an upper end fitting secured to an upper end of the tubing and having an upper stub received in the upper end of the tubing;
(c) a lower end fitting secured to a lower end of the tubing and having a lower stub extending upwardly that is received in the lower end of the tubing.

33. A barrier fence according to claim 32 wherein when the fence is erected on a horizontal surface the tubing extends rearwardly and downwardly from the upper end of the tubing at an angle from the horizontal of at least 40 degrees, more preferably between 50 and 60 degrees.

34. A barrier fence according to claim 32 wherein the tubing between the upper and lower stubs is formed into a smooth arcuate shape in a plane perpendicular to the length of the rail.

35. A barrier fence according to claim 34 wherein the smooth arcuate shape of the tubing between the upper and lower stubs has an approximately constant radius of curvature.

36. A barrier fence according to claim 32 wherein everywhere between the upper and lower stubs the tubing extends in a direction with a downward component and has no sharp corner.

37. A barrier fence according to claim 1 wherein the ground anchor comprises an upper part that in use lies wholly at or adjacent to ground level and that is secured to the lower end of the upright and a lower part that lies below ground level.

38. A barrier fence according to claim 37 wherein the lower part is adapted to be driven into the ground.

39. A barrier fence according to claim 38 wherein the lower part comprises a length of angle with a sharpened bottom edge and oriented so that arms of the angle face the rail when seen in horizontal cross-section.

40. A barrier fence according to claim 37 wherein the ground anchor includes a plate that in use lies flush with the ground surface and extends rearwardly away from the lower part so as to enhance resistance to movement of the ground anchor under rearwardly directed loads applied to the rail.

41. A barrier fence according to claim 40 wherein the said plate comprises an extension of a plate that abuts the lower end of the upright.

42. A barrier fence according to claim 1 wherein the rail comprises a plurality of constant-cross-section rail lengths joined end to end.

43. A barrier fence according to claim 42 including a coupling means between an adjoining pair of said rail lengths the coupling means comprising:
a. a bolt member adapted to be received and slideable longitudinally in an internal volume that lies within an external boundary of the rail when seen in cross-section; and
b. a screw threaded member and a cooperating nut one of the screw threaded member and the nut being captive in the bolt member and the other being tightenable thereto so as to grip a portion of a rail length and secure the elongate member against sliding in the said internal volume.

44. A barrier fence according to claim 43 wherein one of the screw threaded member and the nut is accessible from outside the rail length through a slot in the rail length that communicates with the internal volume.

45. A method for erecting a barrier fence comprising the steps of providing ground anchors let into a ground surface, securing a lower end of an upright to each ground anchor, and securing a rail assembly to upper ends of the uprights.

46. A method according to claim 45 wherein securing of an upright to the rail assembly is in such a manner that in the event of separation of a lower end of an upright separating from its ground anchor the upper end of the upright remains secured to the rail assembly and can rotate about an axis.
